(19) United States
(12) Patent Application Publication
(10) Pub. No.: US 2010/0015306 A1
(43) Pub. Date: Jan. 21, 2010

(54) Method for Preparing a Low Viscosity Whole Grain Flour Slurry

(75) Inventor: Ricardo Pereyra, White Plains, NY (US)

Correspondence Address: BANNER & WITCOFF, LTD.;and ATTORNEYS FOR CLIENT NO. 006943, 10 SOUTH WACKER DR., SUITE 3000, CHICAGO, IL, 60606, US

(73) Assignee: Pepsico, Inc., Purchase, NY (US)

(21) Appl. No.: 12/173,452

(22) Filed: Jul. 15, 2008

(51) Int. Cl. A23L 2/52; A21D 2/00

(52) U.S. Cl. 426/330.2; 426/330; 426/330.3; 426/330.5

(57) ABSTRACT

A method for preparing a low viscosity whole grain flour slurry including hydrating whole grain flour in water heated at a temperature of about 190° F. to about 210° F. and reducing the pH of the flour-water mixture by acidifying the flour-water mixture under agitation to obtain a reduced viscosity whole grain flour slurry.

### FIELD OF THE INVENTION

The present invention relates generally to preparation of a flour slurry. More particularly, the present invention relates to a method for preparing a low viscosity whole grain flour slurry via acidification.

### BACKGROUND

Due to high cholesterol, obesity, and heart disease concerns, many consumers are interested in making healthier choices about their diets. For this reason, a need exists to provide consumers with whole grain, low cholesterol products. However, with fast-paced lifestyles, it is difficult for consumers to prepare healthy meals or snacks. Therefore, a need also exists to provide the consumer with ready-to-eat nutritious products.

Although others have attempted to make drinkable whole grain products, the texture and properties, such as sliminess, thick viscosity and mouthfeel, of the resultant products are undesirable. These undesirable characteristics are, in large part, attributable to the thick viscosity of the whole grain slurries used in preparing the products. Therefore, a need exists for a low viscosity whole grain flour slurry and method for preparing same.

Methods traditionally used in the field to reduce viscosity of whole grain flour slurries include subjecting the flour slurry to a colloid mill and adding an enzyme to the whole grain flour slurry. Both of these methods have significant drawbacks. For example, using a colloid mill to lower the viscosity of a whole grain flour slurry is extremely time consuming, as the slurry must be treated with the colloid mill for at least 45 minutes. Adding an enzyme to the flour-water slurry to reduce the viscosity is also extremely disadvantageous, as these enzymes must be purchased or manufactured at a significant cost. Moreover, the enzyme hydrolyzes the starch flour thereby modifying the structure of the flour which in turn causes the flour to lose its standard of identity as “whole grain”. If the flour loses its standard of identity as “whole grain” one cannot make particular FDA-approved health claims relating to the flour.

The present invention is directed toward satisfying the need that exists in the field, for a cost-effective and time-effective method for preparing a low viscosity whole grain flour slurry. The present invention reduces the viscosity of a whole grain flour-water mixture at least three-fold. Additionally, if used in a beverage, this reduced viscosity whole grain slurry will provide consumers with a healthy and easily consumable product with enhanced texture and drinkability.

### BRIEF SUMMARY

The present invention relates to a method for preparing a low viscosity whole grain flour slurry. It was discovered that a whole grain flour slurry with a low viscosity is useful in many applications, in particular, for use in foods and beverages. In one aspect of the present invention, a flour-water mixture is prepared and subsequently heated and acidified to significantly lower the pH and reduce viscosity to obtain a low viscosity whole grain flour slurry.

In another aspect of the present invention, the reduced viscosity whole grain flour may be added to a beverage.

### DETAILED DESCRIPTION OF THE INVENTION

The present invention relates to whole grain flour slurries. In particular, the present invention relates to a method for preparing a low viscosity whole grain flour slurry by acidifying a flour-water slurry. The whole grain flour may be derived from oats, barley, wheat, quinoa, corn, or mixtures of these grains, although one of ordinary skill in the art would recognize that flours derived from other whole grains may also be used in accordance with the present invention. “Low viscosity” as used herein means less than about 200 cP when measured at a temperature of about 158° F.

In one aspect of the present invention, oat flour may be used. A suitable oat flour has at least 50 percent of the flour with a particle size of 73 microns or less. However, one of ordinary skill in the art would appreciate that various particle sizes may also be used.

In accordance with one aspect of the present invention, whole grain flour is added to water and mixed until the flour is fully hydrated and dispersed in the water. The water is maintained at a suitable temperature to hydrate the flour, typically about 190° F. to about 210° F., for example about 195° F. The water and flour is generally mixed for at least 15 minutes, for example about 20 minutes. This flour-water mixture may be stirred while being heated. More particularly, a Scott Turbon High Shear Mixer may be used to simultaneously stir and heat the flour-water mixture.

A flour to water ratio of about 1:1 to about 1:50 may be used to obtain the flour-water mixture. For example, the flour to water ratio may be about 1:8 to about 1:20. Any suitable amounts of flour and water are contemplated, but generally about 1% to about 50% whole grain flour may be added to about 50% to about 99% water. More specifically, about 5% to about 11% whole grain flour may be added to about 89% to about 95% water. In one aspect, 8% whole grain flour may be added to 92% water.

In accordance with another aspect of the present invention, a mixture of whole grain flours may be added to the water to form the flour-water mixture. For example, a mixture of oat, corn, quinoa, wheat and barley flours may be used. The flours may be present in various combinations and in various amounts, in accordance with the present invention.

Following hydration of the flour in water, the pH of the flour-water mixture is approximately 5 to 7, typically about 6. The viscosity of the flour-water mixture is then reduced by acidifying the flour-water mixture for an effective amount of time, generally at least 15 minutes such as for about 20 minutes. Acidifying the mixture not only reduces its viscosity, but also decreases the pH of the flour-water mixture to about 2 to about 4, for example about 3.

The flour-water mixture may be acidified using food grade acidulants. These food grade acidulants may include phosphoric acid, lactic acid, malic acid and tartaric acid.

One of ordinary skill in the art would recognize that other food grade acidulants may also be used in the present invention. Alternatively, or in addition to, acidifying the flour-water mixture with food-grade acidulants, the mixture may also be acidified using fruit juices. Examples of fruit juices that may be used in accordance with the present invention include, but are not limited to, apple, grape, pear and citrus fruits in general.

Acidification of the flour-water mixture may take place under agitation. A high shear mixer may be used to agitate the mixture. Additionally the mixture may be agitated for a suitable amount of time, generally at least 15 minutes, such as about 20 minutes.

Although homogenizers are usually used in the field to achieve a homogenous mixture, the present invention reduces molecule size by acidifying the mixture without using a homogenizer and/or other high pressure equipment.

Additional food-grade ingredients may also be used in accordance with the present invention. For example, colors, flavors, preservatives, buffers, proteins, sugars, stabilizers and sweeteners can be added to the low viscosity whole grain flour slurry.

One of ordinary skill in the art would appreciate that the list of food-grade ingredients set forth in the immediately preceding sentence is not all-inclusive and that other food-grade ingredients may also be used in the present invention.

In another aspect of the present invention, the reduced viscosity whole grain flour slurry is added to beverages such as, but not limited to, ready-to-drink beverages, fruit juices, dairy beverages and carbonated soft drinks. This list is not all-inclusive and one of ordinary skill in the art would recognize that the slurry may be added to other beverages in accordance with the present invention.

Benefits of the present invention include a substantial reduction in time and cost to prepare a low viscosity whole grain flour slurry and a substantial reduction in the viscosity of the slurry as compared to traditional methods of reducing the viscosity of whole grain oat flour slurries. Moreover, by acidifying the flour-water mixture to obtain a low viscosity whole grain flour slurry, in accordance with the present invention, the flour is easier to process and the need for milling of the whole grain is eliminated. The low viscosity whole grain flour slurry obtained by the present invention also has desirable textural attributes such as reduced and/or eliminated sliminess, smoothness, and overall enhanced mouthfeel and texture, making it an effective and healthy addition to a beverage.

An example of the present invention is as follows:

| | Amount |
|---|---|
| Ingredient | (% by wt.) |
| Whole grain oat flour | 6.84 |
| Water | 89.5 |
| Phosphoric acid | 0.177 |
| Grape juice concentrate | 3.6 |
| (68 Brix) | |

The whole grain oat flour is fully hydrated in water for about 20 minutes at a temperature of approximately 190° F. using a Scott Turbon High Shear Mixer. The whole grain oat flour-water mixture is subsequently acidified with phosphoric acid and grape juice concentrate for about 20 minutes at a temperature of approximately 190° F. to obtain the low viscosity whole grain oat slurry. The viscosity of the flour-water mixture before acidification, via addition of phosphoric acid and grape juice concentrate, is about 1500-2000 cP. The viscosity of the final product is about 200 cP.

As described, the present invention provides a method for preparing a low viscosity whole grain flour slurry, with beneficial attributes and various applications in the food industry and other industries.

The invention may be embodied in other specific forms without departing from the spirit or essential characteristics thereof. The foregoing embodiments, therefore, are to be considered in all respects illustrative rather than limiting the invention described herein. Scope of the invention is thus indicated by the appended claims, rather than by the foregoing description, and all changes that come within the meaning and range of equivalency of the claims are intended to be embraced therein.

What is claimed is:

1. A method for preparing a low viscosity whole grain flour slurry comprising:
a) fully dispersing whole grain flour in water at a ratio of about 1:1 to about 1:50 at a temperature of about 190° F. to about 210° F. to obtain a flour-water mixture; and
b) acidifying the flour-water mixture under agitation to reduce the pH of the flour-water mixture to about 4 to about 2 and to obtain a low viscosity whole grain flour slurry.

2. The method of claim 1 wherein the flour-water mixture is agitated using a high shear mixer.

3. The method of claim 1 wherein the flour-water mixture is acidified using at least one food-grade acidulant.

4. The method of claim 3 wherein the at least one food-grade acidulant is selected from the group consisting of phosphoric acid, lactic acid, malic acid, tartaric acid, and mixtures thereof.

5. The method of claim 1 wherein the flour-water mixture is acidified with at least one fruit juice.

6. The method of claim 1 wherein the flour-water mixture is acidified with at least one fruit juice and at least one food-grade acidulant.

7. The method of claim 1 wherein the pH of the flour-water mixture is reduced to about 3.

8. The method of claim 1 further comprising the step
c) adding the low viscosity whole grain flour slurry to a beverage.

9. The method of claim 1 further comprising the step
c) adding at least one food-grade ingredient to the low viscosity whole grain flour slurry, the at least one food-grade ingredient selected from the group consisting of sweeteners, stabilizers, preservatives, sugars, proteins, colors, flavors and mixtures thereof.

10. The method of claim 1 wherein the whole grain flour is fully dispersed in water at a ratio of about 1:8 to about 1:20.

11. The method of claim 1 wherein the whole grain flour is fully dispersed in water at a ratio of about 1:12.

12. The method of claim 1 wherein the whole grain flour is a mixture of whole grain flours.

13. The method of claim 12 wherein the mixture of whole grain flours is selected from the group consisting of oat, wheat, barley, corn and quinoa.

14. A method for preparing a beverage containing a low viscosity whole grain flour slurry comprising:
a) fully dispersing whole grain flour in water at a ratio of about 1:1 to about 1:50 at a temperature of about 190° F. to about 210° F. to obtain a flour-water mixture; and
b) acidifying the flour-water mixture under agitation to reduce the pH of the flour-water mixture to about 4 to about 2 and to obtain a low viscosity whole grain flour slurry.
c) adding the low viscosity whole grain flour slurry to a beverage.

15. The method of claim 14 wherein the flour-water mixture is agitated using a high shear mixer.

16. The method of claim 14 wherein the flour-water mixture is acidified using at least one food-grade acidulant.

17. The method of claim 16 wherein the at least one food-grade acidulant is selected from the group consisting of phosphoric acid, lactic acid, malic acid, tartaric acid, and mixtures thereof.

18. The method of claim 14 wherein the flour-water mixture is acidified with at least one fruit juice.

19. The method of claim 14 wherein the flour-water mixture is acidified with at least one fruit juice and at least one food-grade acidulant.

20. The method of claim 14 wherein the pH of the flour-water mixture is reduced to about 3.

21. The method of claim 14 further comprising the step
d) adding at least one food-grade ingredient to the low viscosity whole grain flour slurry, the at least one food-grade ingredient selected from the group consisting of sweeteners, stabilizers, preservatives, sugars, proteins, colors, flavors and mixtures thereof.

22. The method of claim 14 wherein the beverage is selected from the group consisting of fruit juices, dairy beverages, and carbonated soft drinks.

23. The method of claim 14 wherein the whole grain flour is fully dispersed in water at a ratio of about 1:8 to about 1:20.

24. The method of claim 14 wherein the whole grain flour is fully dispersed in water at a ratio of about 1:12.

25. The method of claim 14 wherein the whole grain flour is a mixture of whole grain flours.

26. The method of claim 25 wherein the mixture of whole grain flours is selected from the group consisting of oat, wheat, barley, corn and quinoa.
